(19) United States
(12) Patent Application Publication
(10) Pub. No.: US 2006/0184665 A1
(43) Pub. Date: Aug. 17, 2006

(54) Method of acquisition and transmission of a network infrastructure

(75) Inventors: Klaus Reister, Dettingen/Teck (DE); Bernhard Walter, Graben-Neudorf (DE)

Correspondence Address: THE FIRM OF KARL F ROSS, 5676 RIVERDALE AVENUE, PO BOX 900, RIVERDALE (BRONX), NY, 10471-0900, US

(73) Assignee: Hirschmann Automation and Control GmbH

(21) Appl. No.: 11/352,468

(22) Filed: Feb. 10, 2006

(30) Foreign Application Priority Data
Feb. 12, 2005 (DE) 102005006458.2

(51) Int. Cl. G06F 15/173

(52) U.S. Cl. 709/224

(57) ABSTRACT

Network infrastructure and changes thereof are acquired and transmitted automatically to an entire process technology device for immediate display on an on-going basis. The transmission is effected by an ActiveX-Control protocol.

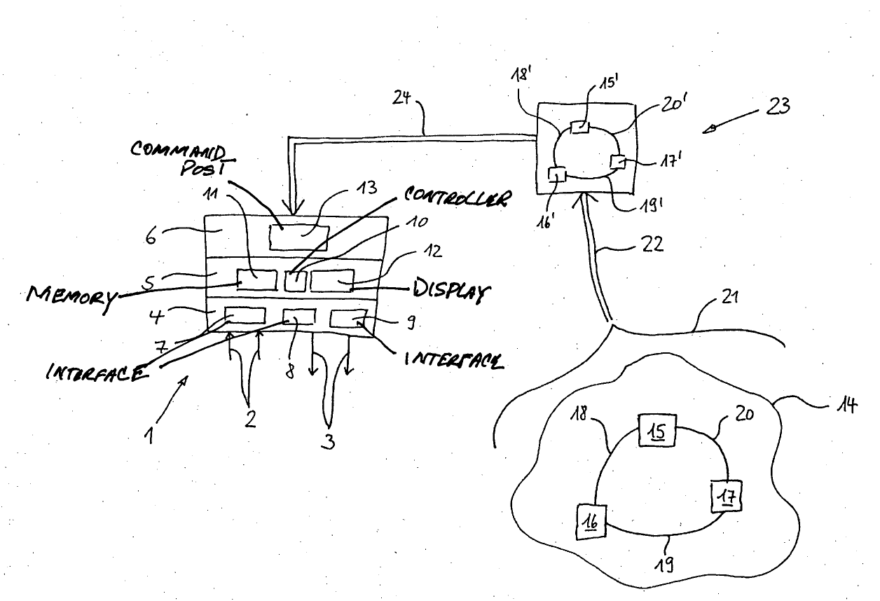

### FIELD OF THE INVENTION

The present invention relates to a method for acquiring and detecting a network infrastructure and of transmitting the acquired network infrastructure, or data, or signals representing same. The invention also relates to an apparatus for acquiring and transmitting the network infrastructure.

### BACKGROUND OF THE INVENTION

In control engineering or technology and especially industrial process engineering or technology, manufacturing processes utilize control devices which, at a command post for the process or plant, acquire and display the control engineering or process engineering parameters. Apart from the parameters which are required for controlling regulation of respective processes, it is known with such units to acquire data which can indicate the units supplying or acting upon the parameters, even if those units are connected to the command post by a network or are connected in a network.

A command unit can, for example, have, or be included in, a certain network infrastructure and can be connected with other units with other network infrastructures, or connected in other network infrastructures. With such devices it is known to display the plan by which the individual components, especially network components, are connected, especially if they are involved in the production process.

Based upon the plan, or prior planning, and the existence of particular units in a particular network, and based upon their interconnection, the control or processing steps can be effected or implemented in the control system. For that purpose, the layout of the network may be communicated to an operator of the apparatus, for example, at the command post. For that purpose, information can be provided as to which components are connected with which other components through the network infrastructure.

However, in the past, the display of the network infrastructure was largely static and, based upon the industrial applications, for example, may be planned using a network management application (software) and indicated or displayed in a Supervisory Control and Data Acquisition System (SCADA Application) (Software). As a result, the implementation often involves twice the cost, since the display is generally provided when the network infrastructure is initially set up, and if modification is required, there usually is another display initiated. Using SCADA, for example, new programming of the display software may be required and, indeed, the programming of the system for modification of the network structure can be time-consuming and expensive.

However, modern requirements for control engineering or industrial process engineering may involve network infrastructure changes frequently without any appreciable time interval between the changes.

Up to now, the skilled worker in the control engineering or industrial processing field had to be content with reprogramming the system at intervals and at high cost when major changes occurred in the network infrastructure or displays of the network infrastructure which would not take into consideration recent and increasingly frequent changes.

There were periods, therefore, at which, prior to reprogramming, the operator of industrial process engineering or technology, for example, for a manufacturing system, would not be aware of changes that had occurred, in a particular network infrastructure and, thus, of the actual state of the network structure even in situations critical to the process. That tended to give rise rapidly to undesirable situations in which the production process was affected and dangerous situations could arise.

### OBJECTS OF THE INVENTION

It is the principle object of the present invention to provide a method whereby the, afore-described drawbacks can be avoided.

Another object is to provide an apparatus or device for carrying out the method of the invention.

### SUMMARY OF THE INVENTION

These objects and others which will become apparent hereinafter are attained, in accordance with the invention, in a method of transmission of a network infrastructure to an industrial process technology device which comprises the steps of:

collecting data as to a network infrastructure to thereby acquire the network infrastructure;

transmitting the acquired infrastructure to an industrial process technology device;

displaying the acquired infrastructure in the industrial process technology device; and

immediately upon a transmission of the acquired infrastructure to the industrial process technology device showing changes in the network infrastructure.

The apparatus can comprise:

a data collector for collecting data as to a network infrastructure to thereby acquire the network infrastructure;

means connected to the data collector for transmitting the acquired infrastructure over a transmission path to an industrial process technology device; and

a display in the industrial process technology device connected to the path for displaying the acquired infrastructure in the industrial process technology device, whereby immediately upon a transmission of the acquired infrastructure to the industrial process technology device changes in the network infrastructure are shown.

According to the invention, therefore, the acquisition of the parameter or the entire network structure is first effected and transmitted to the industrial process engineering device and displayed therein, the transmission being so carried out that changes in the network infrastructure are immediately displayed, that is, on a continuing basis. Since these changes in the network structure can occur at any time, these will be detected and transmitted to the control unit and displayed there on an on-going basis. The altered network structures can be immediately ascertained by the operator at the command post for the process.

The result is an on-going and immediate display of the network infrastructure at the industrial process control center or unit so that the delayed reprogrammings which are cost-intensive can be eliminated. With the invention, the operator of the industrial process engineering system has available, always, the actual state of the network infrastructure on his or her display.

The invention is applicable also with devices which are not used in industrial process technology or engineering. They can be used for the monitoring of SCADA systems generally, for example, to monitor tunnels, conditions in buildings, other apparatuses, or plants and, for example, wind-energy generating farms.

According to a feature of the invention, the transmission of the information, with respect to changes in the network infrastructure is effected by means of ActiveX-Control.

ActiveX-Control can also be used for a variety of components which can be involved in self-standing applications and web pages. All ActiveX technologies can be developed with a Component Object Model (COM). It defines how objects are displayed when they are used in other objects and how objects communicate between processes and/or a network.

It is also possible to use, like ActiveX-Control, a Java Applet to assume the function of ActiveX-Control and which can be available in a self-standing application. The data collectors and transmitter can be a computer work station and can be installed on a PC which, apart from the hardware for acquisition of the altered network infrastructure, also falls under the “means” described below for transmitting at least the changes or the entire altered network infrastructure and displaying the same at the industrial process engineering device. The “means” can be installed itself in the entire process engineering unit and coupled by wire or wirelessly to the transmission path or stretch.

### BRIEF DESCRIPTION OF THE DRAWING

The above and other objects, features and advantages of the invention are described in greater detail below with reference to the accompanying drawing to which the method of the invention is not, however, limited.

The sole FIGURE of the drawing is a diagram illustrating the method.

### SPECIFIC DESCRIPTION

In the drawing, an industrial process engineering or technical device is represented at 1 and can be, for example, a device for carrying out a manufacturing process, a device for performing industrial process engineering, or some other process, including a control process like, for example, the control of an electricity-generating power plant.

The control or regulating process, has certain input parameters on its part, which are represented by the input values 2 to the device 1. Based upon the control or regulating steps performed by the process device 1, control signals or magnitudes 3 are outputted. Customarily, the input magnitudes or parameters 2 derive from sensors and the output magnitudes signals or parameters 3 are applied to effectors.

The device 1 itself can operate on three planes, namely, the plane 4 which is associated with the input and output to the sensors and effectors of the control part of the process, the process plane 5 in which the input parameters 2 are processed and the output parameters 3 are generated, and a command plane 6 which monitors the entire device 1 and applies commands as may be required to achieve the desired result and which can determine which of the sensors 2 and effectors 3 may be effective or operative and which transfer functions to be performed in the process plane 5.

In the field plane 4 depending upon the number of input parameters or magnitudes 2 and/or the number of output parameters or control magnitudes 3 that may be provided, there are interfaces 7, 8, and 9 to which the sensors and effectors are connected and which also may be connected to other input or output devices. The sensors, actuators and optional other devices may be connected in or to a network themselves.

In the process plane 5, at least one memory or storage unit 11 and at least one display or indicator unit 12 are provided.

In the command plane 6 at least one command post or display stage 13 is provided.

The control unit 10 provides the controller regulation of the process in plane 5 as a function of the input magnitudes 2 and optional other parameters which may have been recorded in memory 11 or are derived therefrom. The control unit 10 ensures that the transferred functions to create the control parameters or magnitudes 3 are properly produced and are shown on the display unit 12.

The display unit 12 can also display other information with respect to the system, including the network infrastructure of which the device 1 may form a part or which may be present in the industrial process engineering device itself. Alternatively, or in addition, a display may be provided in the command post 13 to display the network infrastructure of the industrial process engineering device 1. The command plane 6 can be decoupled from the display 12, if desired, and can be arranged to display the network infrastructure only on a display on the command post 13 or via hardware which is intrinsic to the command plane 6. The network infrastructure which is displayed can be that interconnecting a number of industrial processes engineering units or also the network infrastructure of the sensors, actuators and other devices which optionally can be networked as has been noted.

A typical network infrastructure with which the invention is concerned has been shown in the drawing as 14 and described by way of example. The network infrastructure 14 can comprise units 15, 16, 17 which can be connected with one another by cabling 18, 19, 20. The units 15, 16 and 17 can be, for example, switches which are connected to respective units, for example, for networking through the TCP/IP protocol, like, for example, hubs, PC's, memory programmable sensors (SPS) or the like. The cabling 18 through 20 represents conventional network cabling which can connect the elements of the network in a star or ring pattern.

In the drawing, the collection of data of the network infrastructure to thereby acquire the network infrastructure has been represented at 21. The acquired network infrastructure 14 supplied at 22 to the transmission means 23, is transmitted over a path 24.

The unit 23, thus, reflects the network infrastructure 14 with its units 15′, 16′, 17′ and the cabling 18′, 19′, 20′, corresponding to the units 15 through 20 previously described. This means that the unit 23 is in a position to determine changes in the network infrastructure, for example, additions to the units 15 through 20, reductions in those units or replacements of one or more to yield a greater number of units 15 through 17 or a lesser number and to transmit that information over the path 24 to the process device 1. The information (in this example, elements 15′ through 20′) which is detected at 23 and optionally also displayed by that apparatus, is supplied by the path 24 to the unit 1 in a wireless or wired manner. The device 1 which can process the data supplied over the path 24 and can also display that data in the display 13 of the process plane 6 or at other locations in the unit 1, can, thus, respond immediately to the changes. According to the invention, therefore, a continuous acquisition of the network infrastructure response and display or changes therein in the device 1 enables the latter to always show the actual state of the network. The information may be better understood in terms of a short example.

The units 15 through 17 shown in the drawing may be, for example, three sensors which produce the input parameters 2. The device 1 is set up initially, therefore, to operate with three input parameters 2. Should it be determined, for example, that for optimization of the process performed by the industrial processing device 1, a further input parameter 2 and, thus, a further sensor is required, the further sensor can be integrated in the infrastructure 14. In that case, the network will no longer operate with three units, but rather with a total of four (or, optionally even more, depending upon requirements). The unit 23, for example, a workstation which may be a PC, detects a change in the network infrastructure 14, which no longer is operating with only three units, but now has four and immediately transmits the display of the actual state of the network along stretch 24 to the processing unit 1 for display there.

Advantageously, the changes in the network infrastructure are displayed instantaneously in the processing device 1. Instead of only the network infrastructure, the unit 23 can also acquire the parameters of the units 15 through 17 (or more) and transmit them, as well, to the device 1. It should be noted further that each of the units 15 through 17 need not consist of only a single component, but each may be, for example, a switch with a PC connected thereto or even a respective network. Similarly, the command plane 6 and the process plan 5 need not form a single unit as shown, but can be separated from one another and connected by data lines or buses.

1. A method of transmission of a network infrastructure to an industrial process technology device, comprising the steps of:
collecting data as to a network infrastructure to thereby acquire said network infrastructure;
transmitting the acquired infrastructure to an industrial process technology device;
displaying the acquired infrastructure in said industrial process technology device; and
immediately upon a transmission of the acquired infrastructure to said industrial process technology device showing changes in the network infrastructure.

2. The method defined in claim 1 wherein the transmission of the acquired infrastructure is effected by means of ActiveX-Control protocol.

3. An apparatus for transmission of a network infrastructure to an industrial process technology device, comprising:
a data collector for collecting data as to a network infrastructure to thereby acquire said network infrastructure;
means connected to said data collector for transmitting the acquired infrastructure over a transmission path to an industrial process technology device; and
a display in the industrial process technology device connected to said path for displaying the acquired infrastructure in said industrial process technology device, whereby immediately upon a transmission of the acquired infrastructure to said industrial process technology device changes in the network infrastructure are shown.

4. The apparatus defined in claim 3 wherein said data collector and said means is formed by a computer work station.

5. The apparatus defined in claim 4 wherein said computer work station is a PC.
